(19) United States
(12) Patent Application Publication
(10) Pub. No.: US 2006/0161587 A1
(43) Pub. Date: Jul. 20, 2006

(54) Psycho-analytical system and method for audio and visual indexing, searching and retrieval

(75) Inventor: Sky Woo, San Francisco, CA (US)

Correspondence Address: CARR & FERRELL LLP, 2200 GENG ROAD, PALO ALTO, CA, 94303, US

(73) Assignee: Tiny Engine, Inc.

(21) Appl. No.: 11/212,545

(22) Filed: Aug. 26, 2005

Related U.S. Application Data
(63) Continuation-in-part of application No. 11/099,356, filed on Apr. 4, 2005.
(60) Provisional application No. 60/645,135, filed on Jan. 19, 2005.

(51) Int. Cl. G06F 17/30

(52) U.S. Cl. 707/104.1

(57) ABSTRACT

A psycho-analytical system and method for audio and visual indexing, searching and retrieval. Various embodiments of the system comprise a source of audiovisual data; a psycho-analytical converter configured to convert the audiovisual data; a component for storage of the converted audiovisual data; a psycho-analytical indexer configured to index the stored converted audiovisual data as psycho-analytical data; a component for storage of the indexed psycho-analytical data; and a psycho-analytical engine for searching the stored indexed psycho-analytical data. The resulting information is presented by the psycho-analytical engine to a user application and/or to a user.

### CROSS-REFERENCE TO RELATED APPLICATIONS

The present application is a continuation-in-part of and claims the benefit and priority of U.S. patent application Ser. No. 11/099,356 filed on Apr. 4, 2005 for “Systems and Methods for Providing Search Results Based on Linguistic Analysis,” which claims the benefit and priority of U.S. provisional patent application Ser. No. 60/645,135, filed Jan. 19, 2005 and entitled “Systems and Methods for Providing Search Results Based on Linguistic Analysis,” both of which are incorporated herein by reference.

The subject matter of this application is related to U.S. patent application Ser. No. 11/______ filed on ______ and titled “Systems and Methods for Providing User Interaction Based Profiles,” which is incorporated herein by reference.

### BACKGROUND OF THE INVENTION

1. Field of the Invention

The present invention relates generally to search engines, and more particularly to psycho-analytical systems and methods for audio and visual indexing, searching and retrieval.

2. Description of Related Art

In a time often coined “the information age,” people frequently search for information using computing devices. Networks, such as the Internet, have made searching for information more simplified as compared to the process of going to a library and searching a card catalog for a book containing the desired information. With the Internet, a user may enter words or keywords into a website query box in order to find information pertaining to the entered words. The website providing the query box uses a search engine to scrutinize thousands of documents on the Internet and returns documents having the words or keywords entered by the user. When the search engine displays pertinent links to the user, the displayed links are based on the web pages having the most matching keywords.

Another process utilized by conventional search engines is page ranking. Page ranking returns web page links that have the keywords and that have the highest number of other web pages pointing to or linking to that web page. For example, if “web page D” includes the keywords specified by the user and web page D is linked to by web pages A through C, web page D will be listed first among the web pages with the keywords entered by the user. The theory is that the links pointing to web page D are essentially votes for web page D, and if most other web pages point to web page D, then web page D must be the most popular of the web pages having the keywords.

Despite the apparent advantages of search engine technology, however, few of the results returned by a conventional search engine are closely related to the information sought by the user. This is because keywords identified by a search engine in a corresponding document are often used in a context that is different from the context sought by the user. This problem created the need addressed by patent application Ser. No. 11/099,356 filed on Apr. 4, 2005 for “Systems and Methods for Providing Search Results Based on Linguistic Analysis,” which is incorporated herein by reference. Nevertheless, user context characterization is multi-faceted and extends beyond the reach of linguistic analysis. Therefore, there is a need for a psycho-analytical system and method for audio and visual indexing, searching and retrieval.

### SUMMARY OF THE INVENTION

A psycho-analytical system and method for audio and visual indexing, searching and retrieval. The resulting information is presented by a psycho-analytical engine to a user application and/or to a user.

A system according to some embodiments comprises a source of audiovisual data; a psycho-analytical converter configured to convert the audiovisual data; a component for storage of the converted audiovisual data; a psycho-analytical indexer configured to index the stored converted audiovisual data as psycho-analytical data; a component for storage of the indexed psycho-analytical data; and a psycho-analytical engine for retrieving, searching and presenting the stored indexed psycho-analytical data.

In methods according to some embodiments, audiovisual data is sourced and converted to a format suitable for storage. The stored converted audiovisual data is indexed and stored as psycho-analytical data for searching, retrieving and presenting by a psycho-analytical engine.

Other objects, features and advantages will become apparent in view of the following drawings, detailed description and embodiments.

### BRIEF DESCRIPTION OF THE DRAWINGS

FIG. 1 shows an exemplary high-level, simplified architecture for a psycho-analytical system and method for audio and visual indexing, searching and retrieval, according to various embodiments;

FIG. 2 shows an exemplary sectional, simplified architecture of a psycho-analytical system and method, according to various embodiments;

FIG. 3 shows an exemplary schematic for a psycho-analytical system and method for audio and visual indexing, searching and retrieval, according to various embodiments;

FIG. 4 shows an exemplary schematic for a psycho-analytical system and method with respect to a search implementation for one or more applications, according to various embodiments; and

FIG. 5 is an exemplary flowchart showing a method for psycho-analytical audio and visual indexing, searching and retrieval, according to various embodiments.

### DESCRIPTION OF EXEMPLARY EMBODIMENTS

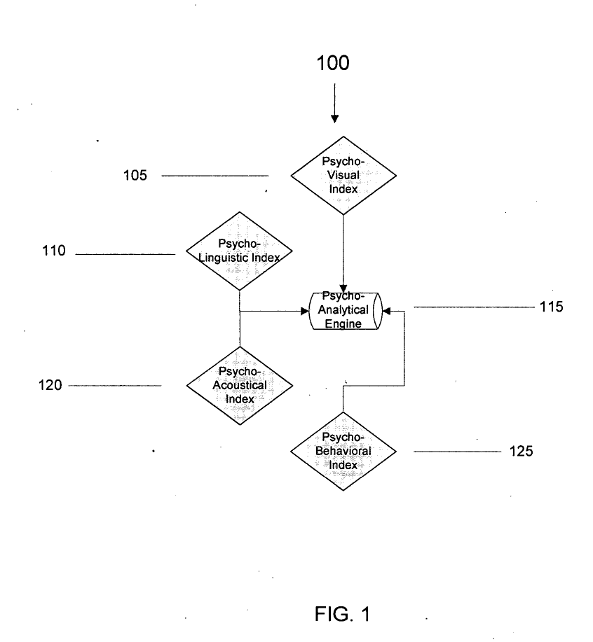

FIG. 1 shows an exemplary high-level, simplified architecture 100 for a psycho-analytical system and method for audio and visual indexing, searching and retrieval, according to various embodiments. Some embodiments have four psycho-analytical indexes: a psycho-visual index 105; a psycho-linguistic index 110; a psycho-acoustical index 120; and a psycho-behavioral index 125. A typical embodiment has a psycho-analytical engine 115.

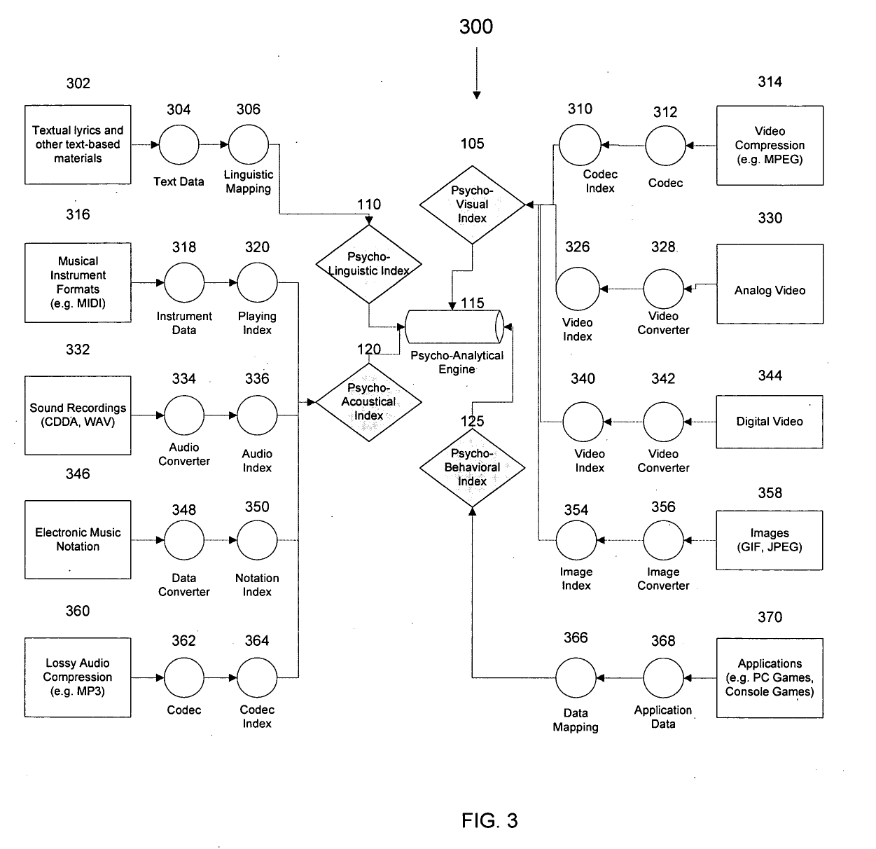

Each of the four psycho-analytical indexes shown in FIG. 1 receives indexed psycho-analytical data from constituent indexes as described more fully in connection with FIG. 3. Various embodiments of psycho-linguistic indexes are described in U.S. patent application Ser. No. 11/099,356 for “Systems and Methods for Providing Search Results Based on Linguistic Analysis,” filed on Apr. 4, 2005 and incorporated herein by reference. Although various indexes have been described in association with architecture 100, fewer or more indexes may comprise architecture 100 and still fall within the scope of various embodiments.

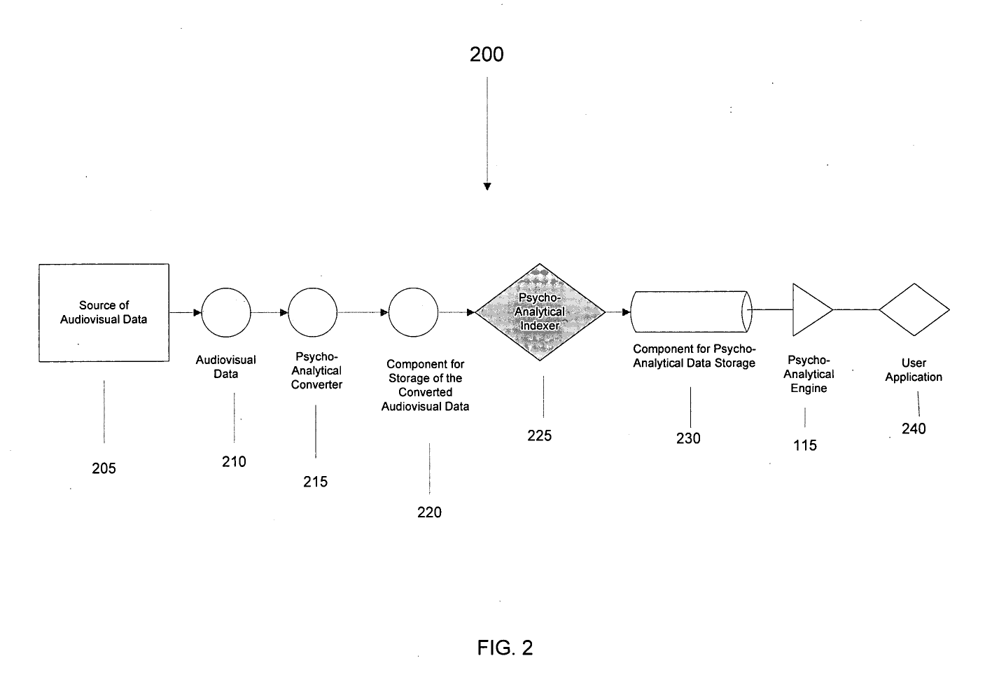

FIG. 2 shows an exemplary sectional, simplified architecture 200 of a psycho-analytical system and method for audio and visual indexing, searching and retrieval, according to various embodiments. The sectional, simplified architecture 200 includes a source of audiovisual data 205, audiovisual data 210, a psycho-analytical converter 215 and a component for storage of the converted audiovisual data 220.

One or more sources of audiovisual data 205 provide audiovisual data 210 to a psycho-analytical converter 215. The psycho-analytical converter 215 can be an implementation of existing psycho-acoustical software, psycho-visual software and/or a software converter designed specifically for psycho-analytical indexing. The psycho-analytical converter 215 converts the audiovisual data 210 to an encoded intermediate format suitable for storage. The psycho-analytical converter 215 converts the audiovisual data 210 based on psycho-analytical methods such as psycho-acoustical, psycho-visual, psycho-behavioral, psycho-linguistic, codec, rule set and/or mapping structure methods. The converted audiovisual data is stored in a component for storage of the converted audiovisual data 220.

Architecture 200 includes a psycho-analytical indexer 225, a component for psycho-analytical data storage 230, a psycho-analytical engine 115 and a user application 240. A psycho-analytical indexer 225 receives the converted audiovisual data from the component for storage of the converted audiovisual data 220. The psycho-analytical indexer 225 indexes the stored converted audiovisual data as psycho-analytical data. After the psycho-analytical indexer 225 indexes the stored converted audiovisual data, the indexed psycho-analytical data is stored in a component for psycho-analytical data storage 230. A psycho-analytical engine 115 receives stored indexed psycho-analytical data from the component for psycho-analytical data storage 230. The psycho-analytical engine 115 searches and retrieves stored indexed psycho-analytical data for presentation to a user application 240 and/or directly to a user. Although various components are discussed in association with architecture 200, fewer or more components may comprise architecture 200 and still fall within the scope of various embodiments.

FIG. 3 shows an exemplary schematic 300 for a psycho-analytical system and method for audio and visual indexing, searching and retrieval, according to various embodiments.

Shown in schematic 300 are some of the sources of audiovisual data 205 (FIG. 2) compatible with various embodiments of the systems and methods described herein. Audiovisual data sources 205 (FIG. 2) include textual lyrics and other text-based materials 302; compressed video (e.g. MPEG) 314; musical instrument formats (e.g. MIDI) 316; analog video 330; sound recordings (e.g. CCDA, WAV) 332; digital video 344; electronic music notation 346; images (e.g. GIF, JPEG) 358; Lossy audio compression (e.g. MP3) 360; and applications (e.g. PC games, console games) 370.

Other sources of audiovisual data 205 (FIG. 2) include:

(1) Compressed and/or Lossy audio formats: MP3 (e.g. MPEG-1 Level 3: Moving Picture Experts Group™), MP3-Pro, WMA (Windows™ Media Audio), RealAudio™, QuickTime™, Ogg (e.g. Ogg Vorbis™), AIFF (e.g. Audio Interchange File Format), AU, ATRAC3, ATRAC3plus, AAC (e.g. Advanced Audio Coding), Liquid Audio™, SHN (e.g. Shorten™), SWA and other similar formats;

(2) Musical Instrument Data Formats: MIDI (e.g. Musical Instrument Digital Interface), MOD, XMF (e.g. Extensible Music Format), KAR, OSC (e.g. Open Sound Control), mLAN™ (by Yamaha™), SDII (e.g. Sound Designer II™), SDMI (e.g. Secure Digital Music Initiative), RMF, SMDI (e.g. SCSI Musical Data Interchange) and other similar formats;

(3) Lossless Recording Quality Formats: CDDA, WAV (e.g. WAVForm™), PCM, ALE (e.g. Apple™ Lossless), TTA, FLAC (e.g. Free Lossless Audio Codec), BWF (e.g. Broadcast Wave Format), AU and other similar Lossless sound recording files;

(4) Compressed Video Formats: MPEG-1, MPEG-2, MPEG-4 (e.g. DivX, XviD, FFmpeg, etc.), WMV (e.g. Windows™ Media Video), AVI (e.g. Audio/Video Interleaved), DV (e.g. Digital Video), QuickTime™, RealVideo™, ASF, DVD;

(5) Analog Video Formats: NTSC, PAL, SECAM and other Analogue Video Formats;

(6) Digital Video Formats: ATSC, DVB, ISDB and other Digital Video Formats;

(7) Vector Image Formats: Flash™, Shockwave™ and other Vector Image Formats;

(8) Graphic Image Formats: GIF (e.g. Graphic Interchange Format), JPEG (e.g. Joint Photographic Experts Group™), BMP (e.g. Windows™ Bitmap Image), TIFF (e.g. Tag Image File Format) and other formats; and

(9) Video game graphics, motion, textures, sounds and voice in various formats depending on implementation.

Referring to FIG. 3, schematic 300 shows a first codec 312, a first video converter 328, an audio converter 334, a second video converter 342, a data converter 348, an image converter 356, and a second codec 362.

Codec 312 and codec 362 compress and/or decompress audiovisual data 210 (FIG. 2). Preassembled sets of codecs, commonly referred to as “codec packs,” are commercially available for use on personal computers (“PCs”) for compressing and/or decompressing audiovisual data found on the Internet. A psycho-analytical converter 215 (FIG. 2), such as a first video converter 328, an audio converter 334, a second video converter 342, a data converter 348, or an image converter 356, converts audiovisual data 210 (FIG. 2) to an intermediate format suitable for indexing.

In typical embodiments, most of the sources of audiovisual data 205 (FIG. 2) are configured to convert, compress and/or decompress in particular patterns. These patterns can be seen and/or heard by the human eye and/or ear, respectively. Accordingly, these patterns are used for indexing. Audiovisual data configured in a MPEG format, such as that shown in MPEG 314, uses a form of psycho-visual coding recognized by the corresponding codec 312. Audiovisual data configured in a MP3 format, such as that seen in MP3 360, uses a form of psycho-acoustical coding recognized by the corresponding codec 362. Other embodiments use components similar to codecs to code the information that forms concepts, ideas, expressions, views, descriptions, subjects, topics and the organizational patterns found in linguistics, visual perception, auditory perception and human behavior.

Shown in schematic 300 are some of the representative constituent psycho-analytical indexes of the psycho-visual index 105; the psycho-linguistic index 110; the psycho-acoustical index 120; and the psycho-behavioral index 125. The psycho-visual index 105 includes a video codec index 310; an analog video index 326; a digital video index 340; and an image index 354. The psycho-linguistic index 110 is directly linked to linguistic mapping 306, with the source of audiovisual data originating from text data 302. Examples of text data 302 can include film scripts and song lyric sheets. The psycho-acoustical index 120 includes a musical instrument playing index 320; a sound recording audio index 336; an electronic music notation index 350; and a Lossy audio codec index 364. The psycho-behavioral index 125 is directly linked to applications data mapping 366, with the source of audiovisual data originating from applications data 370.

In addition to the multitude of psycho-analytical indexes described herein, secondary layers of applications or plug-ins can be used to index the following psycho-analytical dimensions:

(1) Attitude Dimensions: attitude dimensions are measures of human viewpoint with respect to the world, other people, events and concepts. Some of these dimensions include, but are not limited to, the identification of common sense, personal sense, personal outlook, mannerisms, opinions, future concerns, inspiration, motivation, insight, beliefs, values, faith, reactions to actions, cultural surroundings, combativeness, litigiousness, personal preferences, social preferences, feelings of competence and sophistication;

(2) Behavioral Dimensions: behavioral dimensions are measures of human behavior and human reaction to events and other personal and worldly matters. Some of these dimensions include, but are not limited to, the identification of personal temperament, disposition, character, emotional feelings, metaphysical beliefs, psychological state, criminality, need states, physical states and decision making processes;

(3) Business Dimensions: business dimensions are measures of human perspective toward business matters. Some of these dimensions include, but are not limited to, the identification of economic, monetary, financial and career related tasks, talents, innovation and skills;

(4) Cognitive Dimensions: cognitive dimensions are measures of how humans think. Some of these dimensions include, but are not limited to, the identification of ways of thinking, reasoning, intellectual quotient, memory and self-concept;

(5) Communicative Dimensions: communicative dimensions are measures of how humans express and convey ideas, concepts, understandings and thoughts. Some of these dimensions include, but are not limited to, the identification of verbalization, narration, acts of sharing, acts of statement, acts of publicizing, listening, gossiping, chatting, negotiation, musical expression, profanity, slang, euphemism, propaganda, media sources, readability, comprehension, speaking style and writing style;

(6) Consumer Dimensions: consumer dimensions are measures of human points of view with respect to purchase decisions. Some of these dimensions include, but are not limited to, the identification of brand sensitivity, lifestyle, leisure tendency, localized knowledge and life cycle changes;

(7) Demographic Dimensions: demographic dimensions are a measure of the relationships of humans in certain segments of the population. Some of these dimensions include, but are not limited to, the identification of age, audience appropriateness, gender, geographic, socioeconomic trends, income, ethnic and racial preference, nationality, product and service usage, spending and purchasing;

(8) Social Dimensions: social dimensions are measures of the relationships of humans to other people, organizations and ideals. Some of these dimensions include, but are not limited to, group dynamics, individuality, team, family, friends, influences, leadership, credibility, membership, professionalism, politics, societal roles and truthfulness;

(9) Sensory and Perceptual Dimensions: sensory and perceptual dimensions are measures of human understanding of the surrounding physical world through human senses. Some of these dimensions include, but are not limited to, the identification of visualizations, sound, tactility, time, spatiality and relative place; and

(10) Subject and Special Interest Dimensions: subject and special interest dimensions are measures of human interest in subjects and topics of knowledge and representation. Some of these dimensions include, but are not limited to, subjects about life and events, arts, humanities, business, trade, computers, technology, health, medicine, products, services, technical sciences and social sciences.

In accordance with various embodiments, psycho-analytical indexing as described herein can be used for a variety of applications. For example, in most musical compositions, sound patterns and sound representations such as musical notations are repeated. Repeated sound patterns and sound representations can be psycho-acoustically indexed by encoding methods. Sound patterns, perceptual encoding (such as Huffman encoding, MPEG audio encoding or other similar perceptual encoding techniques), embedded ID tags, meta-tags, vocal samples, notations, lyrics and other data related to sound quality, intensity, perception, meaning and identification can be psycho-acoustically indexed. Additionally, sound patterns including notes, pitch, timing, scales and groups of frequencies, can be psycho-acoustically indexed.

Another embodiment encompassing psycho-analytical indexing is with respect to video and/or image presentations. In most video or image presentations, visual or image patterns are repeated and clustered. Repeated images and video patterns can be psycho-visually indexed by encoding methods. Additionally, image and video patterns (including shapes, areas of concentration, color saturation, hue, contrast, brightness and groups of frequencies) can be psycho-visually indexed.

A further embodiment encompassing psycho-analytical indexing is with respect to psycho-behavioral indexing. As represented by the various embodiments described in U.S. patent application Ser. No. ______ titled “Systems and Methods for Providing User Interaction Based Profiles,” and incorporated herein by reference, structured and repeated interactions of software users with a particular aspect of a software program, such the steps required to perform a particular function, can be psycho-behaviorally indexed. Such psycho-behavioral indexes can be used to represent the perceptions of users about the software program and/or the accompanying hardware device. Similarly, the structured and repeated interactions of users with a particular video game can be psycho-behaviorally indexed to represent the perceptions of users about the particular video game.

Although various components are discussed in association with schematic 300, fewer or more components may comprise schematic 300 and still fall within the scope of various embodiments.

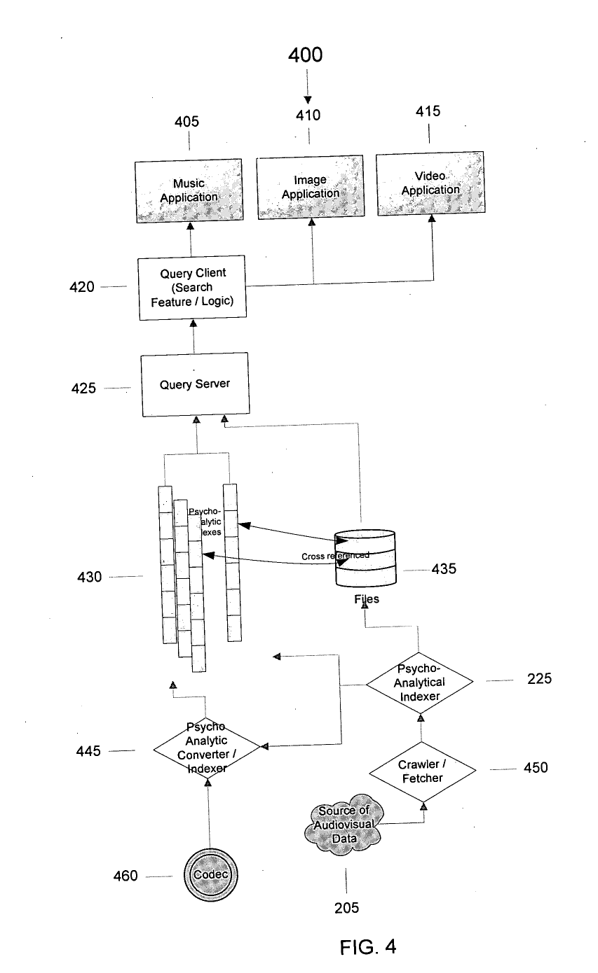

FIG. 4 shows an exemplary schematic 400 of a psycho-analytical system and method with respect to a search implementation for one or more applications, according to various embodiments. The schematic 400 shows a music application 405, an image application 410, a video application 415 and a client-server 420-425 functioning as a psycho-analytical engine. Also shown in schematic 400 are psycho-analytical indexes 430, files 435, file indexer 225, psycho-analytical converter/indexer 445, crawler/fetcher 450, a source of audiovisual data 205 and codec 460.

Client-server 420-425 functions as a psycho-analytical engine by retrieving and searching stored indexed psycho-analytical data from psycho-analytical indexes 430. Psycho-analytical indexes 430 can represent such psycho-analytical indexes as those shown and described in connection with FIG. 3. Psycho-analytical indexes 430 store psycho-analytical data indexed by file indexer 225 and psycho-analytical converter/indexer 445. Client-server 420-425 also retrieves and searches indexed stored psycho-analytical data from files 435. Files 435 store psycho-analytical data indexed by file indexer 225. Psycho-analytical converter/indexer 445 receives audiovisual data from codec 460. File indexer 225 receives audiovisual data from crawler/fetcher 450. Crawler/fetcher 450 downloads audiovisual data from one or more sources of audiovisual data 205.

Psycho-analytical indexes 430 supply indexed stored psycho-analytical data to files 435. Files 435 or other similar components cross-reference the psycho-analytical data contained in indexes such as the psycho-analytical indexes 430, psycho-visual index 105 (FIGS. 1 & 3), the psycho-linguistic index 110 (FIGS. 1 & 3), the psycho-acoustical index 120 (FIGS. 1 & 3), the psycho-behavioral index 125 (FIGS. 1 & 3) and/or other indexes. Files 435 can also be programmed with logical connections to support the psycho-analytical engine 115 (FIGS. 1-3) and 420-425. For example, according to some embodiments, video and images can be indexed to sound and music. Video and images can be indexed to words. Sound and music can be indexed to words. In some embodiments, a music application can play music and display images according to the psycho-analytical data indexed for a song file and related source files. In other embodiments, an image or video editing application can suggest music and sounds to fit a particular image or video. In alternative embodiments, a speech writing application can suggest music and images to fit a particular text.

In accordance with some embodiments, psycho-analytical engine performance can be optimized by methods such as a link graph voting method. Various embodiments of the link graph voting method are described in U.S. patent application Ser. No. 11/099,356 for “Systems and Methods for Providing Search Results Based on Linguistic Analysis,” which is incorporated herein by reference. The link graph voting method takes into account some or all of the indexed psycho-analytical data linked to a particular item of indexed psycho-analytical data. For example, a happy song mood linked to a happy song will result in the psycho-analytical engine associating a particular value to the happy song. This value would be different from the value which would be associated with the happy song if a sad song mood was linked to it. Accordingly, the link graph voting method can be used to increase the likelihood of the psycho-analytical engine searching, retrieving and presenting the happiest song choice available to the user application 240 (FIG. 2); 405 (FIG. 4) and/or to the user.

Other linked indexed psycho-analytical data may be used with the link graph voting method to adjust the value associated with a particular item of indexed psycho-analytical data. For example, a happy song mood linked to a happy image will result in the psycho-analytical engine associating a particular value to the happy image. This value would be different from the value which would be associated with the happy image if a sad song mood was linked to it. Most any manner of referencing and valuing linked indexed psycho-analytical data with a particular item of indexed psycho-analytical data may be used with the link graph voting method, with the determination of the manner used influenced to a varying degree by the desired objective imparted by the user and/or user application on the psycho-analytical engine.

Although various components are discussed in association with schematic 400, fewer or more components may comprise the schematic 400 and still fall within the scope of various embodiments.

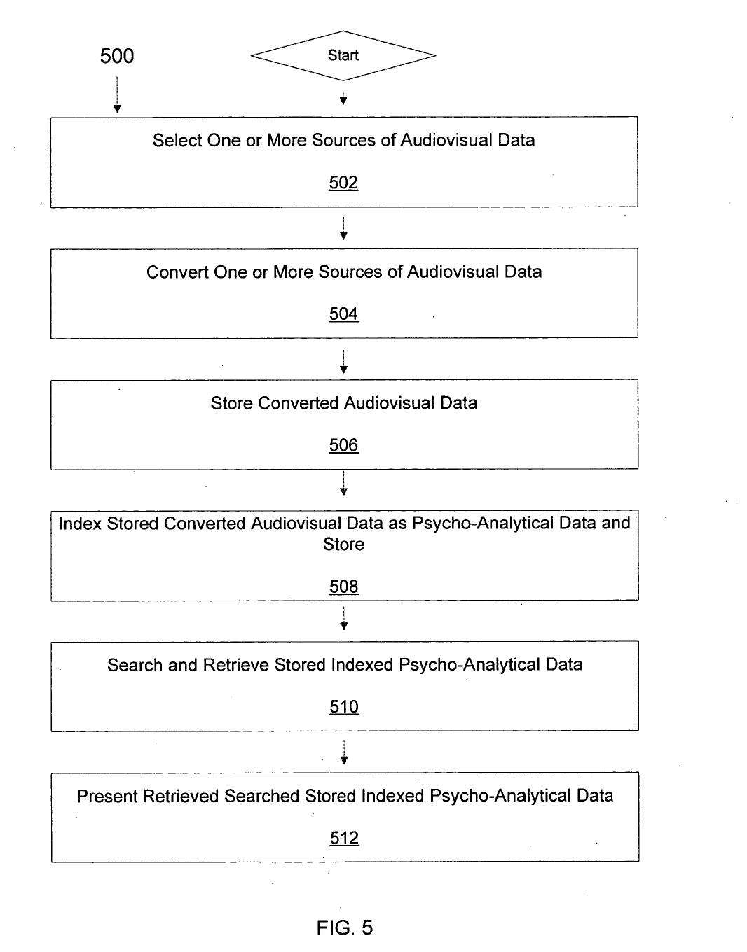

FIG. 5 is an exemplary flowchart 500 showing a method for psycho-analytical audio and visual indexing, searching and retrieval, according to various embodiments.

At step 502, one or more sources of audiovisual data 205 (FIGS. 2 & 4) are selected.

With respect to music, in some embodiments, selected sources of audiovisual data 205 (FIGS. 2 & 4) can include the lyrics of a song (textual) 302 (FIG. 3); the background information about a song (textual) 302 (FIG. 3); a music video for a song (MPEG) 314 (FIG. 3); a musical instrument playing a sample of a song (MIDI) 316 (FIG. 3); and a compression of a song sound recording (MP3) 360 (FIG. 3).

With respect to photography, in some embodiments, selected sources of audiovisual data 205 (FIGS. 2 & 4) can include a text description of an image (textual) 302 (FIG. 3); background information about an image (textual) 302 (FIG. 3); a vector construction of an image (Flash™); a compression of an image (JPEG, GIF) 358 (FIG. 3); and an image (e.g. picture or photo) 358 (FIG. 3).

With respect to videos, in some embodiments, selected sources of audiovisual data 205 (FIGS. 2 & 4) can include a text description of the video (textual) 302 (FIG. 3); background information about a video (textual) 302 (FIG. 3); frames of a video (MPEG) 314 (FIG. 3); animation (Flash™); and a video (e.g. motion picture or animation) 330 (FIG. 3).

At step 504, the one or more selected sources of audiovisual data 205 (FIGS. 2 & 4) from step 502 are converted with a psycho-analytical converter 215 (FIG. 2). The psycho-analytical converter 215 (FIG. 2) converts audiovisual data 210 (FIG. 2) to an intermediate format based on various psycho-analytical methods, such as psycho-acoustical, psycho-visual, psycho-behavioral, psycho-linguistic, codec, rule set and/or mapping structure methods. A psycho-analytical converter 215 (FIG. 2), such as a first video converter 328 (FIG. 3), an audio converter 334 (FIG. 3), a second video converter 342 (FIG. 3), a data converter 348 (FIG. 3) and/or an image converter 356 (FIG. 3), performs the requisite conversion of the source audiovisual data 210 (FIG. 2). The psycho-analytical converter 215 (FIG. 2) also converts the audiovisual data 210 (FIG. 2) to an encoded format for storage.

At step 506, the converted audiovisual data is stored in a component for storage of the converted audiovisual data 220 (FIG. 2).

At step 508, the stored converted audiovisual data is indexed as psycho-analytical data by a psycho-analytical indexer 225 (FIGS. 2 & 4). After the psycho-analytical indexer 225 (FIGS. 2 & 4) has indexed the stored converted audiovisual data, the indexed psycho-analytical data is stored in a component for psycho-analytical data storage 230 (FIG. 2) or index, such as the psycho-visual index 105 (FIGS. 1 & 3); the psycho-linguistic index 110 (FIGS. 1 & 3); the psycho-acoustical index 120 (FIGS. 1 & 3); the psycho-behavioral index 125 (FIGS. 1 & 3) or one or more of the constituent psycho-analytical indexes, including the video codec index 310 (FIG. 3); the musical instrument playing index 320 (FIG. 3); the analog video index 326 (FIG. 3); the sound recording audio index 336 (FIG. 3); the digital video index 340 (FIG. 3); the electronic music notation index 350 (FIG. 3); the image index 354 (FIG. 3); and/or the Lossy audio codec index 364 (FIG. 3).

At step 510, a psycho-analytical engine 115 (FIGS. 1-3) and 420-425 (FIG. 4) searches and retrieves psycho-analytical data from one or more of the psycho-analytical indexes. As described herein, psycho-analytical indexes can be cross-referenced and programmed with logical connections to support the psycho-analytical engine.

At step 512, the psycho-analytical engine 115 (FIGS. 1-3) and 420-425 (FIG. 4) presents the searched and retrieved psycho-analytical data to a user application 240 (FIG. 2), such as a music application 405 (FIG. 4), an image application 410 (FIG. 4), a video application 415 (FIG. 4), and/or to the user.

With respect to music, in some embodiments, a psycho-analytical engine 115 (FIGS. 1-3) and 420-425 (FIG. 4) can present to a music application 405 (FIG. 4) and/or directly to a user information such as:

1. Song keywords;

2. Song artists;

3. Song formats;

4. Song moods (e.g. happy, sad, angry, pathetic);

5. Song feelings (e.g. upbeat, downbeat, frantic, head-banging, complex, annoying); and

6. Song styles (e.g. bluesy, jazzy and/or folksy).

With respect to photography, in some embodiments, a psycho-analytical engine 115 (FIGS. 1-3) and 420-425 (FIG. 4) can present to an image application 410 (FIG. 4) and/or directly to a user information such as:

1. Image information;

2. Image keywords;

3. Image artists/authors/source;

4. Image file formats;

5. Image moods (e.g. happy, sad, angry, pathetic);

6. Image feelings (e.g. blurred, sharp, high contrast, bright, energetic); and

7. Image styles (e.g. photographic, classical art, impressionistic, graphic designed).

With respect to videos, in some embodiments, a psycho-analytical engine 115 (FIGS. 1-3) and 420-425 (FIG. 4) can present to a video application 415 (FIG. 4) and/or directly to a user information such as:

1. Video keywords;

2. Video sources;

3. Video file formats;

4. Video moods (e.g. happy, sad, humorous, political);

5. Video feelings (e.g. dark, sharp, color saturated, high contrast, bright, energetic, depressing); and

6. Video styles (e.g. action-packed, slow, stop-action, still-framed, high quality production, home-video).

In accordance with various embodiments described in connection with U.S. patent application Ser. No. ______ for “Systems and Methods for Providing User Interaction Based Profiles,” a monitor tracks the activities of a user on a network. The monitor tracks activities such as user searches, requests, actions or other types of information retrieved by the user. The information the user obtains from the network may have been previously indexed using the various embodiments described herein. The monitor is coupled to an indexer that indexes user activities to create a user profile. The user profile comprises indexed psycho-analytical data and any other dimensions that may comprise the profile of the user. The user profile can then be matched to the psycho-analytical data contained in a variety of software applications and hardware devices.

Software applications and hardware devices compatible with the various psycho-analytical indexes described herein include PC software, server software, web based software, embedded hardware (such as that found on cell phones or PDAs) and hardware devices in places as diverse as refrigerators and cars. Further, advertising, marketing and sales software applications are compatible with the various psycho-analytical indexes described herein. For example, software applications found on stereos and other music devices are configured for song parameters such as artist, format, style and volume. In various embodiments, a user profile can be matched to the song parameters to adjust the music according to the user profile. Additionally, various embodiments can be integrated with pod-cast applications and other live transmissions for live audio or video. Similar systems can be used on audio and video recording devices, such as TivO™, for collecting, grouping and presenting different sets of music or video according to pre-defined psycho-analytical criteria.

While various embodiments have been described above, it should be understood that they have been presented by way of example only, and not limitation. For example, any of the elements may employ any of the desired functionality set forth hereinabove. Thus, the breadth and scope of a preferred embodiment should not be limited by any of the above-described embodiments.

What is claimed is:

1. A psycho-analytical system for audio and visual indexing, searching and retrieval comprising:
a source of audiovisual data;
a psycho-analytical converter configured to convert the audiovisual data;
a component for storage of the converted audiovisual data;
a psycho-analytical indexer configured to index the stored converted audiovisual data as psycho-analytical data; and
a component for storage of the indexed psycho-analytical data.

2. The psycho-analytical system of claim 1, further comprising a psycho-analytical engine for searching the stored indexed psycho-analytical data.

3. The psycho-analytical system of claim 2, wherein the psycho-analytical engine retrieves at least part of the searched stored indexed psycho-analytical data.

4. The psycho-analytical system of claim 3, wherein at least part of the retrieved searched stored indexed psycho-analytical data is presented to a user.

5. The psycho-analytical system of claim 3, wherein at least part of the retrieved searched stored indexed psycho-analytical data is presented to a user application.

6. The psycho-analytical system of claim 3, wherein at least part of the retrieved searched stored indexed psycho-analytical data is presented to a music application.

7. The psycho-analytical system of claim 3, wherein at least part of the retrieved searched stored indexed psycho-analytical data is presented to an image application.

8. The psycho-analytical system of claim 3, wherein at least part of the retrieved searched stored indexed psycho-analytical data is presented to a video application.

9. The psycho-analytical system of claim 3, wherein at least part of the retrieved searched stored indexed psycho-analytical data is presented to a server application.

10. The psycho-analytical system of claim 3, wherein at least part of the retrieved searched analyzed stored indexed psycho-analytical data is presented to a hardware device.

11. A psycho-analytical method for audio and visual indexing, searching and retrieval comprising:
sourcing audiovisual data;
converting the audiovisual data to a format suitable for encoded data storage;
storing the converted audiovisual data in an encoded format;
indexing the stored converted audiovisual data as psycho-analytical data; and storing the indexed psycho-analytical data.

12. The psycho-analytical method of claim 11, further comprising searching the stored indexed psycho-analytical data.

13. The psycho-analytical method of claim 12, further comprising retrieving at least part of the searched stored indexed psycho-analytical data.

14. The psycho-analytical method of claim 13, further comprising presenting to a user at least part of the retrieved searched stored indexed psycho-analytical data.

15. The psycho-analytical method of claim 13, further comprising presenting to a user application at least part of the retrieved searched stored indexed psycho-analytical data.

16. The psycho-analytical method of claim 13, further comprising presenting to a server application at least part of the retrieved searched stored indexed psycho-analytical data.

17. The psycho-analytical method of claim 13, further comprising presenting to a hardware device at least part of the retrieved searched stored indexed psycho-analytical data.

18. A psycho-analytical method for audio and visual indexing, searching and retrieval comprising:
sourcing audiovisual data;
converting the audiovisual data to a format suitable for encoded data storage;
storing the converted audiovisual data in an encoded format;
indexing the stored converted audiovisual data as psycho-analytical data;
storing the indexed psycho-analytical data;
searching the stored indexed psycho-analytical data; and
retrieving at least part of the searched stored indexed psycho-analytical data.

19. The psycho-analytical method of claim 18, further comprising presenting to a user application at least part of the retrieved searched stored indexed psycho-analytical data.

20. The psycho-analytical method of claim 18, further comprising presenting to a user at least part of the retrieved searched stored indexed psycho-analytical data.
